(19) United States
(12) Patent Application Publication
(10) Pub. No.: US 2008/0021648 A1
(43) Pub. Date: Jan. 24, 2008

(54) 3 and 4 dimensional display of forecast hazards linked to the movement of the subject along a future path in space and time

(76) Inventor: Ian A. Wilson, Port Orange, FL (US)

Correspondence Address: Pennington, Moore, Wilkinson, Bell & Dunbar, P.A., Post Office Box 10095, Tallahassee, FL, 32302-2095, US

(21) Appl. No.: 11/726,192

(22) Filed: Mar. 21, 2007

Related U.S. Application Data
(60) Provisional application No. 60/784,334, filed on Mar. 21, 2006.

(51) Int. Cl. G08G 1/16

(52) U.S. Cl. 701/301

(57) ABSTRACT

The present invention comprises a new method and system for presentation of forecast hazards to vehicles that allows the incremental advance of the time of the display showing the movement of the vehicle in 3 dimensions as an overlay on the movement of hazards to the vehicle also in 3 dimensions. The display itself may be simple 2 dimensional display of the 3 dimensional trajectory and hazards at a particular time, or be a rotatable 3 dimensional display of a particular time. The invention intelligently interpolates the position or existence/disappearance of hazards then providing the capability to the user to move the displayed position of the vehicle in time along its 4 dimensional trajectory and then displays the position or existence of the hazards at the time matching that of the current vehicle position. This allows the user to assess whether the hazards will interfere with the vehicle as it follows its trajectory.

### BACKGROUND OF THE INVENTION

1. Field of the Invention

This invention relates to provision of hazard information from a moving or intermittent hazard to a user or vehicle moving along a path or a trajectory in space such that the user is shown the relative forecast or relative historic movement or existence of the hazard in relation to the forecast or historic movement of the user or vehicle through time and space.

For the purposes of the present disclosure a ‘Vehicle’ is defined as anything manned or unmanned moving through time and space that is sensitive to hazards that are also moving in time or space or hazards that are coming into existence and ceasing to exist over time.

There are many fields in which a user or a vehicle are traveling and hazards are forecast that may affect them en-route. Examples could be container ships attempting to avoid high wave heights; military reconnaissance trying to avoid or fluid moving troop concentrations or aircraft pilots or dispatchers wishing to ensure that an aircraft's trajectory does not penetrate weather hazards. However, the forecasts of the hazards that the user wishes to avoid are often presented as snap-shots of the position(s) of the hazards at large temporal granularities. For example: storm positions are often forecast with 2 hour separation between forecasts. If the user is planning to traverse the area between the times of the forecast it can be difficult to assess whether the hazard will affect the user or not.

The subject invention is a simple method of displaying both the movement of the subject user or vehicle and the forecast or historic movement or existence of the hazard(s) by advancing and retarding the time of the display. The forecast hazard is graphically displayed and the changes between the current forecast and the previous or next forecast are linked by incremental changes in the graphics at a finer temporal granularity. The temporal granularity is reduced by the amount necessary to make the changes between the graphics displayed appear to be ‘smooth’. The time shown on the display may be changed by several means but the more intuitive is to allow the display user to use a mouse pointer or roller ball (or similar device) to ‘click on’ the displayed subject vehicle symbol giving a display of that vehicle's path in time and space. Then using a display control, perhaps by clicking on the displayed vehicle, alter the vehicle symbol position along its path or trajectory into the future or the past. As the vehicle symbol moves along the path in accordance with the displayed time, the hazards on the display also move and are displayed for the time that equates to the vehicles position on the path or trajectory.

This display provides a user with the capability to assess whether the moving or appearing hazards will be present and close enough to the trajectory or path to cause a hazard to the vehicle

2. Description of the Related Art

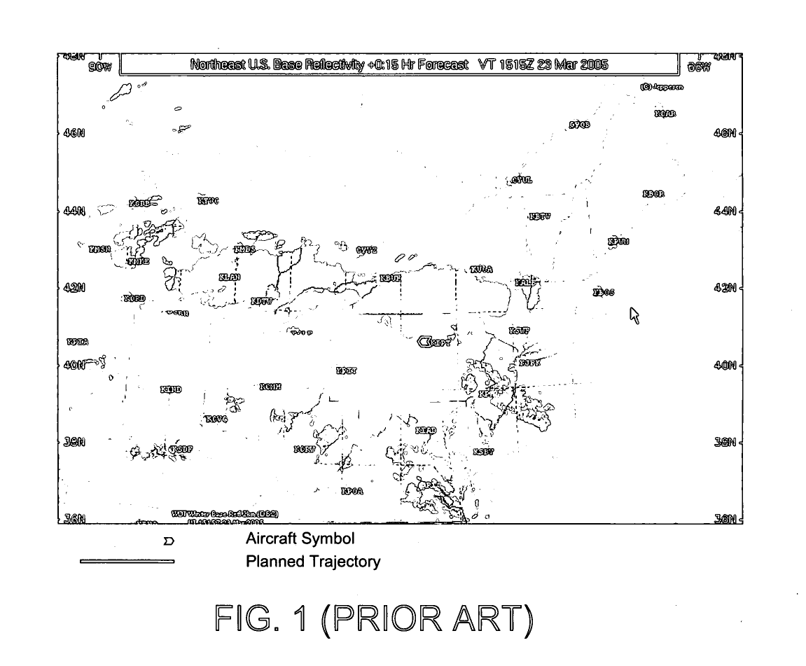

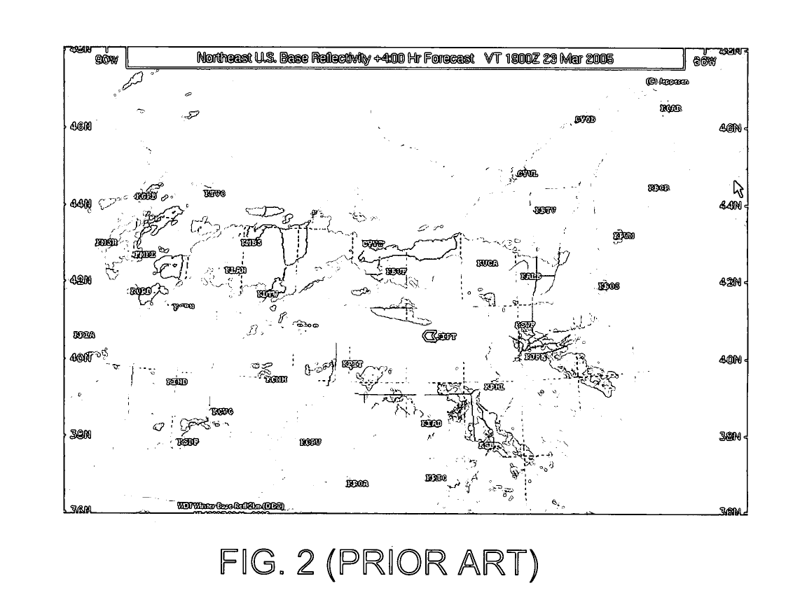

There are many systems that display current hazards such as weather affecting aircraft and ships. Some systems show future position of hazards but they do this at a large temporal granularity. To identify whether a hazard will affect them a user has to assess current hazard positions and the forecast future positions and mentally interpolate whether those hazards will affect their progress along their desired path which in an aircraft may be include altitude changes. FIG. 1 shows the expected position of weather in a 15 minutes time and FIG. 2 shows the forecast position in 4 hour's time. The pilot of the aircraft shown with the blue symbol needs to estimate the arrival time of the leading edge of the weather to see if the hour long flight along the trajectory in red is feasible taking off an hour from now and landing in 3 hours. If it is not, the pilot must determine how much alteration would be required in the flight path to ensure that the weather hazard is avoided. Currently pilots must make mental estimates about the location of hazards from these two widely spread forecasts.

### BRIEF SUMMARY OF THE INVENTION

The current invention is intended to provide visual graphical assistance to the pilot (or other similar users with other vehicles and hazards). The trajectory of the vehicle is displayed with the vehicle at a position on the trajectory that equates to a particular time. Therefore, for example if take off is at 12:00 then the display time is set to 12:00 and the aircraft is shown at the beginning of the trajectory. The user can then incrementally alter the time of the display—this could be done by dragging the aircraft symbol along the trajectory or moving a display time bar or some other method. As the time is incrementally altered the aircraft symbol moves along the trajectory to the expected position at the display time; the hazard information (in the example forecast weather) also moves to the forecast position at the display time. The gaps between the forecast values are interpolated by the display using information on trend and hazard movement from the forecast if available. Thus the invention provides far better information allowing the user to assess whether forecast hazards will affect the trajectory of the vehicle.

The present invention comprises a new method of providing information on hazards to vehicles manned or unmanned moving through time and space that is sensitive to hazards that are also moving in time or space or hazards that are coming into existence and ceasing to exist over time, by displaying the position and motion of the vehicle over a time sequenced 3 dimensional rotatable display of the forecast movement or existence of the hazards at a temporal granularity that matches the movement of the vehicle. The display therefore has the ability to (1) show the trajectory of the vehicle as a 4-dimensional continuum (i.e. a 3-dimensional line in space where the time that the vehicle will be at each point along that line is known); (2) show the interpolation of the hazard in the same 4 dimensions; (3) account for user input time to display both the forecast and interpolated hazard position and the expected vehicle position at the user input time; and (4) rotate the display on user input to view the vehicle trajectory and hazard position from different viewpoints.

### REFERENCE NUMERALS IN THE DRAWINGS

1. vehicle movement data (The planned movements of the vehicle are entered into the system automatically or manually)

2. discrete hazard data (The forecast hazard movements and existence disappearance of hazards are entered into the system either automatically or manually)

3. vehicle movement database (The movements of the vehicle are stored in a database)

4 hazard database (The forecast hazard movements and existences are stored in a database)

5process (A process reads the vehicle movements from the database [3] and generates a 4 dimensional trajectory for the vehicle)

6 process (A process reads the hazard movements from the hazard database [4] and generates a 4 dimensional interpolation of the movement of the hazards and their existence disappearance)

7 user input (The selects the vehicle of interest and inputs and/or varies the time to be displayed. The user may also input rotation increments to allow views of the 3 dimensional weather at a particular time from different viewpoints)

8 process (A process reads the 4 dimensional vehicle trajectory from [5] and 4 dimensional hazard positions [6] and passes them to the user display)

9 display (The user display shows the position of the selected vehicle at the input time [7] and overlays that on the display of the hazard(s) at the input time)

### DETAILED DESCRIPTION OF THE INVENTION

The operation of the current invention can be described by expanding on the example of a pilot preparing to fly from Williamsport Regional Airport over Cleveland Hopkins Airport to South Bend Regional Airport. The aircraft planned track running almost due West is running ahead of a weather front which is forecast to contain icing conditions. The aircraft flight is expected to last 3 hours from 1 hour's time to 4 hours' time but the only weather forecasts published show the weather as it is expected to be in around 15 minutes and as it will be in 4 hours' time. The pilot then would need to estimate the likely movement of the front and plot the movement of the aircraft to assess whether the hazardous weather will affect the aircraft.

The current invention would load the information about the hazards that the users of the system were concerned about and build an interpolated set of forecasts at a suitable temporal granularity. That is a series of graphics showing the front at temporal increments of say 5 minutes. The display also would access the information on the planned trajectory of the aircraft.

The user can now select the moving 4D hazard display the aircraft will be displayed on the trajectory at the position it is at the current time. This may be at the start point or end point if times outside the flight time are chosen. Then the time displayed may be altered by the user by (but not limited to) the following means: (1) by ‘clicking on’ the aircraft symbol with a mouse pointer or roller ball pointer and then ‘dragging’ the aircraft along the trajectory in time backward or forward; (2) By selecting the current time display and altering the time displayed by inputting times; (3) By selecting a time ‘slide’ control and moving the time displayed to any time within the times of the flight described by the trajectory.

As the time displayed is altered the aircraft and the hazard are displayed in the positions that they are forecast to be at the time displayed. This approach allows the user to assess whether they are affected by the hazard moving close to, into or across their path.

This animated graphical approach for provision of hazards to vehicles could be used by many types of interest other examples could be (1) Military aircraft wishing to avoid overflying moving hostile formations; (2) Container ships wishing to avoid ocean areas where wave heights exceed safe limits; and (3) Emergency vehicles entering an area wishing to avoid moving hazards such as areas of high winds or polluted air.

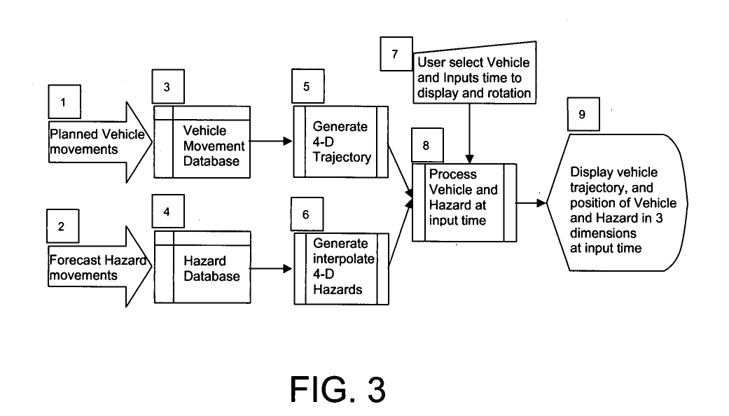

FIG. 3 shows the process underlying the current invention. The data on the vehicle movements are input into the system [1]. In aviation terms this would be the flight plan of an aircraft. The information is then saved in a database of vehicle movements [3].

Similarly the forecast hazards are input into the system, this could be a weather forecast, a wave height forecast, or expected changes in the disposition of enemy troops. This forecast hazard information is then stored in a hazard movement database [4] A system process [5] then takes the vehicle movement information and converts it into a 4 dimensional trajectory allocating times to each 3 dimensional position on the trajectory.

A system process [6] takes the hazard information and generates a 4 dimensional interpolation of the movement or existence and disappearance of the hazard(s). The interpolation may entail some intelligence in the generation of the movement of the hazard or may be a simple graphical ‘morphing’ of one shape into another shape.

The user can select the vehicle of interest and input times or change times for the display [7]. This user input is fed to the process [8] which obtains the vehicle trajectory from the process [5] and the interpolated hazard movements from process [6] and passes the information of the position of the vehicle and hazards at the time selected by the user to display [9].

The display [9] shows the trajectory of the vehicle, the vehicle position at the input time and the hazards at the input time. The display would be in rotatable 3 dimensional format but for ease of diagrams is shown as a 2 dimensional overhead view.

Note the user may input times in the past as well as in the future allowing assessment of vehicle movement against hazards in the past.

### EXAMPLE

For a worked example of the current invention an aviation case will be used. The pilot has entered a flight plan [1] from Williamsport Regional Airport over Cleveland Hopkins Airport to South Bend Regional Airport. The flight will take approximately 3 hours and will be departing Williamsport Regional Airport in an hour's time. A weather forecast for 15 minutes time (issued about 4 hours ago) and some current satellite imagery were put into the computer system [2]; and the new forecast for 4 hours time has just been entered into the system [2]. The weather forecasts show that there is a broken weather front with a gap between weather also shown on the current satellite imagery. The forecasts show that Williamsport Regional Airport will soon be in clear weather [FIG. 1] however a second frontal system is moving northward with icing expected that the 4 hour forecast shows will be well across the planned flight path of the aircraft [FIG. 2]. The pilot has to decide whether the flight path as planned will be sufficiently clear of the weather hazards to be safe.

The pilot selects his aircraft [7] on the system. The system selects the 4 dimensional trajectory that has been generated for that aircraft [5] and the weather that has been interpolated [6] and the trajectory is shown on the display as it will be in an hour's time at takeoff with the weather as it has been interpolated for an hour's time. [8][9].

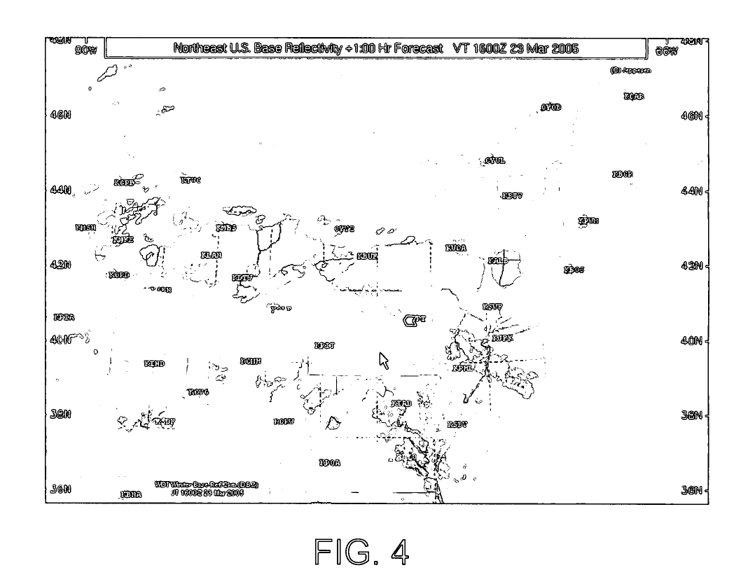

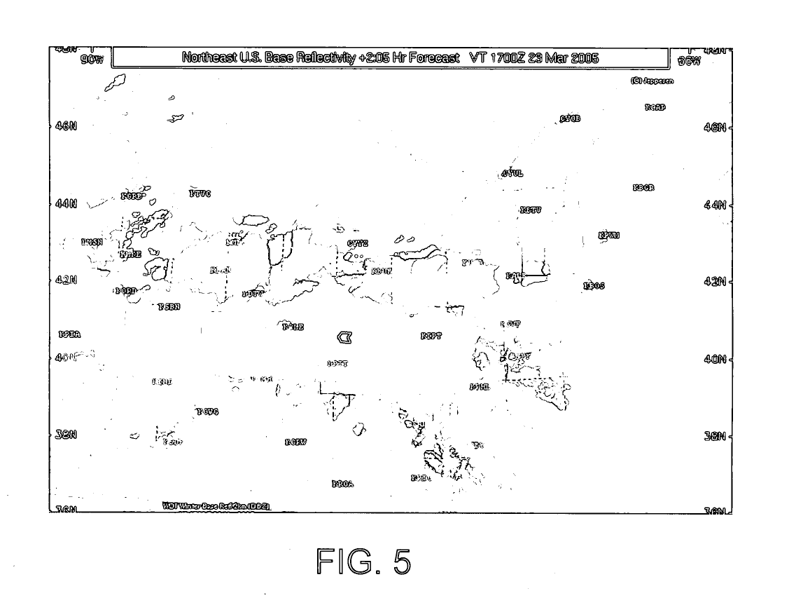

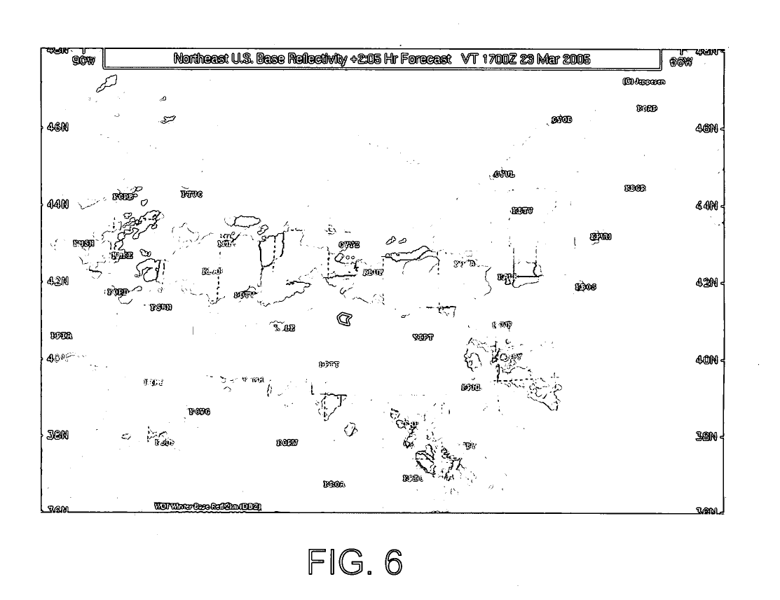

The display [9] (in FIG. 4) shows that the trajectory passes very close to the advancing front so the pilot now advances the time on the display in this case by dragging the aircraft symbol along the trajectory [7]. As the aircraft position is moved along the trajectory each incremental change is taken as a change in time the pilot stops at 2:05 hours into the flight trajectory and the display [9] shows that the interpolated forecast is that the leading edge of the front will be crossing the flight path of the aircraft at the time that the aircraft is there [FIG. 5].

The pilot considering this trajectory too risky inputs [1] a new flight path into the system to stay clear of the weather hazard. The flight path is stored [3] and then processed to create a 4 dimensional trajectory [5]. The pilot then selects the new flight plan and a time [7] the system process [8] reads the 4 dimensional trajectory and the 4 dimensional weather and passes them to the display [9] to be displayed at the user input time.

The display [9] for the time 2:05 hours into the flight now shows that the change has taken the aircraft clear of the weather and the pilot can now confirm the flight plan amendment.

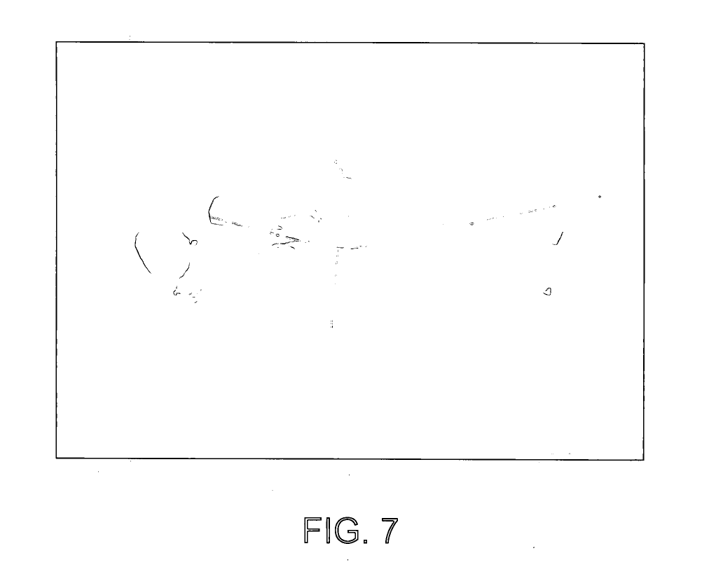

The current invention is the display of 4 dimensional vehicle trajectories against forecast hazards in 4 dimensions with the temporal increments of the forecasts reduced from hours to a granularity of 5 minutes or less. For ease of display and description 2 dimensional figures have been used in this paper. The invention is not limited to 2 dimensional display and can either height filter hazards so that hazards that are not at the same altitude as the vehicle trajectory are not shown or can display the hazards and the aircraft trajectory(ies) in rotatable 3 dimensions. FIG. 7 is illustrative of the type of graphics that could be produced using the present invention.

What is claimed is:

1. A system for displaying forecasted hazards relative to the movement of a subject along a future path in space and time to a user, comprising:
a. subject movement data describing said movement of said subject along said future path in space and time including a first time, a second time, and at third time;
b. a first set of forecasted hazard data describing the location of said forecasted hazards in space at said first time;
c. a second set of forecasted hazard data describing the location of said forecasted hazards in space at said second time, said second time different than said first time;
d. a means for automatically generating a third set of forecasted hazard data describing said forecasted hazards in space at said third time using said first set of forecasted hazard data and said second set of forecasted hazard data, said third time occurring temporally between said first time and said second time;
e. a means for correlating the location of said subject along said future path with the location of said forecasted hazard as said subject moves along said future path in space and time; and
f. a display means configured to progressively display the location of said forecasted hazards at said first time, said third time, and said second time along with the location of said subject at said first time, said third time, and said second time.

2. The system of claim 1, further comprising an input means configured to allow said user to select a chosen location of said subject along said future path.

3. The system of claim 2, wherein said display means is configured to display the location of said forecasted hazards corresponding to the time in which said subject is at said chosen location.

4. The system of claim 1, wherein said display means is configured to display said forecasted hazards in 4 dimensions.

5. A method for displaying forecasted hazards relative to the movement of a subject along a future path in space and time to a user, comprising:
a. providing subject movement data describing said movement of said subject along said future path in space and time including a first time, a second time, and at third time;
b. providing a first set of forecasted hazard data describing the location of said forecasted hazards in space at said first time;
c. providing a second set of forecasted hazard data describing the location of said forecasted hazards in space at said second time, said second time different than said first time;
d. automatically generating a third set of forecasted hazard data describing said forecasted hazards in space at said third time using said first set of forecasted hazard data and said second set of forecasted hazard data, said third time occurring temporally between said first time and said second time;
e. providing a means for correlating the location of said subject along said future path with the location of said forecasted hazard as said subject moves along said future path in space and time;
f. displaying the location of said forecasted hazards along with said location of said subject at said first time; and
g. displaying the location of said forecasted hazards along with said location of said subject at said third time after displaying the location of said forecasted hazards along with said location of said subject at said first time.

6. The method of claim 5, further comprising the step of providing an input means configured to allow said user to select a chosen location of said subject along said future path.

7. The method of claim 6, further comprising the step of automatically displaying the location of said forecasted hazards corresponding to the time in which said subject is at said chosen location.
